(19) United States
(12) Patent Application Publication
(10) Pub. No.: US 2022/0305521 A1
(43) Pub. Date: Sep. 29, 2022

(54) CARTRIDGE-BASED EXTRUSION DISPENSER

(71) Applicant: Newer Commuter, LLC, Santa Monica, CA (US)

(72) Inventor: Andrew C. Scherer, Santa Monica, CA (US)

(73) Assignee: Newer Commuter, LLC, Santa Monica, CA (US)

(21) Appl. No.: 17/705,742

(22) Filed: Mar. 28, 2022

Related U.S. Application Data
(60) Provisional application No. 63/167,302, filed on Mar. 29, 2021.

(51) Int. Cl. B05C 17/01

(52) U.S. Cl. CPC B05C 17/0113; B05C 17/0136; B05C 17/0116

(57) ABSTRACT

A cartridge-based extrusion dispenser assembly includes a carriage configured to hold a fluid cartridge, and a flexible strip system coupled to a plunger and including a first flexible tape operably associated with a second flexible tape. Within the carriage, the first and second flexible tapes opposingly reinforce each other to establish a substantially rigid shaft member. An actuator assembly is configured to feed the first and second flexible tapes into the carriage to advance the plunger to engage the fluid cartridge and dispense fluid therefrom.

### CROSS-REFERENCE TO RELATED APPLICATIONS

This application claims the benefit of U.S. Provisional Application Ser. No. 63/167,302, filed on Mar. 29, 2021. The disclosure of the above application is incorporated herein by reference in its entirety.

### FIELD

The present disclosure relates generally to cartridge-based extrusion dispensers and, more particularly, to a cartridge-based extrusion dispenser with a compact split shaft storage arrangement.

### BACKGROUND

Conventional extrusion dispensers, such as caulking guns, typically include an electrically or mechanically actuated piston to selectively dispense caulking or other fluent material from a cartridge or container onto a desired surface. In common mechanical applications, the cartridge is loaded into a caulk gun housing and a push rod is driven by a handle mounted trigger. Actuation of the trigger advances the push rod into engagement with an integrated cartridge piston or cartridge bottom, thereby driving the cartridge bottom and forcing material from a nozzle of the cartridge. However, the greater the volume of fluent material in the cartridge, the greater the combined length of the caulking gun and push rod, which can make it difficult to transport or operate in small spaces with full or partially full cartridges. Moreover, common mechanical actuators often stay engaged after advancing the push rod causing an undesirable “pullback” motion of the push rod when the trigger is returned to its original position, or otherwise cause unintended locking of the push rod, which may require an additional disengagement device to enable the push rod to be pulled back and re-set to the original position. Thus, while such conventional systems work well for their intended purpose, there remains a desire for improvement in the relevant art.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to various aspects of the present disclosure, a cartridge-based extrusion dispenser assembly is provided. In one example, the extrusion dispenser assembly includes a carriage configured to hold a fluid cartridge, and a flexible strip system coupled to a plunger and including a first flexible tape operably associated with a second flexible tape. Within the carriage, the first and second flexible tapes opposingly reinforce each other to establish a substantially rigid shaft member. An actuator assembly is configured to feed the first and second flexible tapes into the carriage to advance the plunger to engage the fluid cartridge and dispense fluid therefrom.

In addition to the foregoing, the described dispenser assembly may include one or more of the following features: wherein the first flexible tape has a concave-convex shape; wherein the second flexible tape has a concave-convex shape; a first rounded guide channel configured to redirect the first flexible tape extending from the carriage back toward the carriage when the plunger is retracted; and a second rounded guide channel configured to redirect the second flexible tape extending from the carriage back toward the carriage when the plunger is retracted.

In addition to the foregoing, the described dispenser assembly may include one or more of the following features: a first support arm extending adjacent the carriage, a first channel extending along the first support arm, and a first retractor member coupled to a first end of the first flexible tape and slidingly disposed within the first channel, wherein sliding the first retractor member toward a distal end of the carriage retracts the first flexible tape and the plunger; and a second support arm extending adjacent the carriage, a second channel extending along the second support arm, and a second retractor member coupled to a first end of the second flexible tape and slidingly disposed within the second channel, wherein the sliding the second retractor member toward the distal end of the carriage retracts the second flexible tape and the plunger.

According to various aspects of the present disclosure, a cartridge-based extrusion dispenser assembly is provided. In one example, the extrusion dispenser assembly includes a carriage configured to hold a fluid cartridge, a shaft member extending at least partially into the carriage and coupled to a plunger, and an actuator assembly configured to feed the shaft member into the carriage to advance the plunger to engage the fluid cartridge and dispense fluid therefrom. The actuator assembly includes a carrier assembly including a pair of opposed grips configured to selectively grip the shaft member, and a trigger assembly. The trigger assembly is configured to, when actuated, move to (i) a first position to selectively engage the carrier assembly to actuate the pair of opposed grips and grip the shaft member, and (ii) a further second position to advance the carrier assembly and feed the shaft member into the carriage. When the trigger assembly is released from the second position, (i) the pair of opposed grips disengage the shaft, and (ii) the carrier assembly is retracted away from the carriage while the carrier assembly is disengaged from the shaft member to thereby facilitate preventing movement of the shaft member in the reverse direction

In addition to the foregoing, the described dispenser assembly may include one or more of the following features: wherein the actuator assembly further comprises a biasing mechanism configured to bias the trigger assembly to a resting position; wherein when the trigger assembly is biased to the resting position, the trigger assembly engages the carrier assembly and forces the pair of opposed grips to disengage the shaft member; and wherein when the trigger assembly is biased to the resting position, the trigger assembly further engages the carrier assembly and retracts the carrier assembly away from the carriage while the carrier assembly is disengaged from the shaft member.

In addition to the foregoing, the described dispenser assembly may include one or more of the following features: a main housing at least partially housing the actuator assembly; wherein the carriage is slidingly coupled to the main housing; wherein the trigger assembly is rotatably coupled to the main housing via a pivot pin; wherein the pair of opposed grips includes a first grip coupled to the carrier assembly, and a second grip rotatably coupled to the carrier assembly; wherein the trigger assembly further includes an actuator pin configured to selectively engage and rotate the second grip into a first position where the shaft member is gripped between the first and second grips, and selectively engage and rotate the second grip into a second position away from the shaft member to thereby disengage the shaft member; wherein the actuator assembly further comprises a biasing mechanism configured to bias the carrier assembly rearward and away from the carriage to a resting position; and a friction member configured to frictionally engage the shaft member to facilitate preventing reverse movement thereof when the trigger assembly is released.

According to various aspects of the present disclosure a cartridge-based extrusion dispenser assembly is provided. In one example, the extrusion dispenser assembly includes a carriage configured to hold a fluid cartridge, and a flexible strip system coupled to a plunger and including a first flexible tape operably associated with a second flexible tape. Within the carriage, the first and second flexible tapes opposingly reinforce each other to establish a substantially rigid shaft member. An actuator assembly is configured to feed the shaft into the carriage to advance the plunger to engage the fluid cartridge and dispense fluid therefrom. The actuator assembly includes a carrier assembly including a pair of opposed grips configured to selectively grip the shaft, and a trigger assembly. The trigger assembly is configured to, when actuated, move to (i) a first position to selectively engage the carrier assembly to actuate the pair of opposed grips and grip the shaft member, and (ii) a further second position to advance the carrier assembly and feed the shaft member into the carriage. When the trigger assembly is released from the second position, (i) the pair of opposed grips disengage the shaft, and (ii) the carrier assembly is retracted away from the carriage while the carrier assembly is disengaged from the shaft member to thereby facilitate preventing movement of the shaft member in the reverse direction

In addition to the foregoing, the described dispenser assembly may include one or more of the following features: wherein the first and second flexible tapes each have a concave-convex shape, first and second rotatable rollers configured to respectively redirect the first and second flexible tapes extending from the carriage back toward the carriage when the plunger is retracted, and a pair of support arms extending adjacent the carriage and each including a channel defined therein. First and second retractor members are respectively coupled to first ends of the first and second flexible tapes and each slidingly disposed within one channel, and a biasing mechanism configured to bias the trigger assembly to a resting position. When the trigger assembly is biased to the resting position, the trigger assembly is configured to engage the carrier assembly and (i) force the pair of opposed grips to disengage the shaft, and (ii) retract the carrier assembly away from the carriage while the carrier assembly is disengaged from the shaft member.

### BRIEF DESCRIPTION OF THE DRAWINGS

The present disclosure will become more fully understood from the detailed description and the accompanying drawings, wherein:

FIG. 1 is a perspective view of an example cartridge-based extrusion dispenser assembly according to some implementations of the present disclosure;

FIG. 2 is a sectional view of the extrusion dispenser assembly shown in FIG. 1;

FIG. 3 is an enlarged view of an example actuator assembly of the extrusion dispenser assembly shown in FIG. 2;

FIG. 4 is a side view of an alternative example trigger and actuator assembly that may be utilized with the extrusion dispenser shown in FIG. 1; and

FIG. 5 is a sectional view of an example alternative actuator assembly that may be utilized with the extrusion dispenser assembly shown in FIG. 1.

### DETAILED DESCRIPTION

The present disclosure is directed to a rodless cartridge-based extrusion dispenser (e.g., a caulk gun) that includes an actuator shaft formed of two material strips or bands (e.g., metal tape) with a concave-convex shape more flexible in a first direction along a perpendicular axis and resistant to flexure in a second opposite direction along the perpendicular axis. When disposed against each other in opposite flexural orientations, the flexible bands work in unison to support each other and facilitate preventing flexure of the combined unit in both directions along the perpendicular axis, thereby functioning as a conventional push rod. However, when the flexible bands are withdrawn into a housing and separated by flexing each band in its respective direction of flexibility, each flexible band is bent and redirected in a desired direction and manner. This allows the flexible bands to be stored within the extrusion dispenser assembly in a fully retracted position without projecting from the caulk gun housing like a typical push rod.

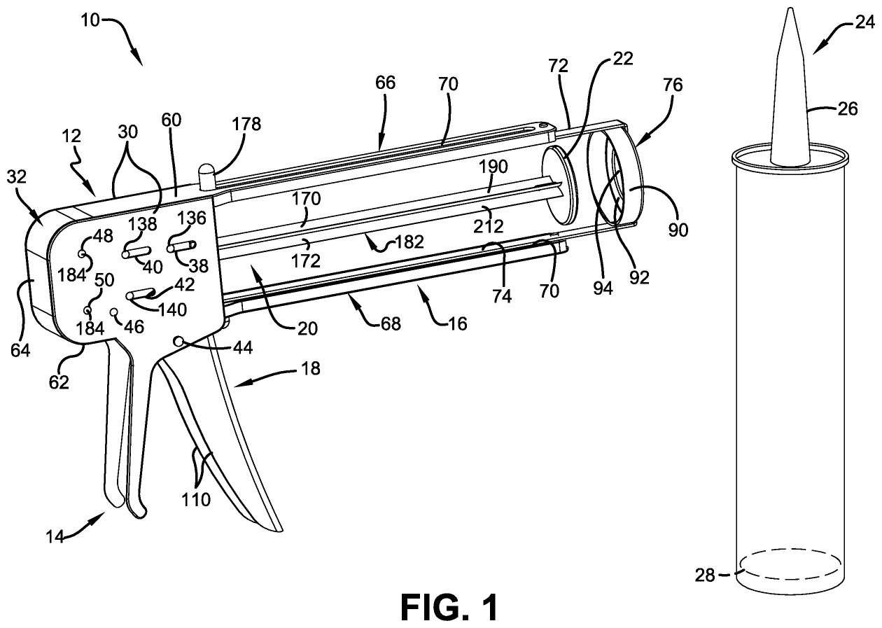

With initial reference to FIG. 1, an extrusion dispenser assembly constructed in accordance to one example of the present disclosure is shown and generally identified at reference 10. In the example embodiment, extrusion dispenser assembly 10 generally includes a main housing 12 with a handle 14 and a tube holder or carriage 16 extending therefrom. The main housing 12 at least partially houses an actuator assembly 18 configured to interact with a flexible strip system 20 to selectively deploy a piston or plunger 22. The carriage 16 is configured to receive a conventional caulk cartridge 24 having a nozzle 26 and an internal piston 28 disposed behind a volume of caulk or other fluent, viscous material. When deployed, plunger 22 engages and drives the internal piston 28 to thereby expel the caulk or other material from the nozzle 26.

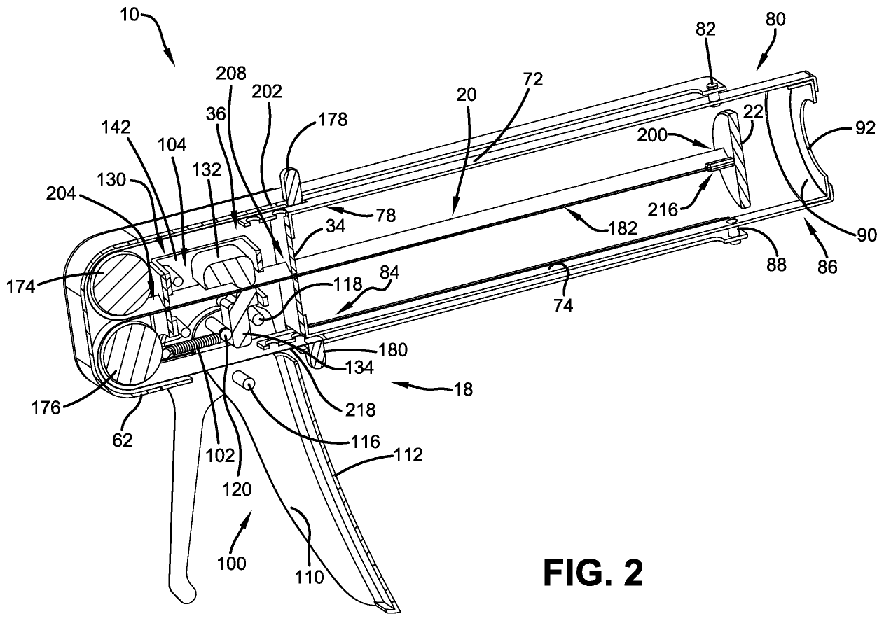

With additional reference to FIGS. 1 and 2, in the example embodiment, the main housing 12 generally includes a pair of laterally spaced apart plate members or side walls 30, a perimeter housing member 32, and a forward plate member or wall 34 together configured to at least partially define an inner cavity 36 (FIG. 2) enclosing at least a portion of the actuator assembly 18 and flexible strip system 20. Each side wall 30 includes a portion of the handle 14 extending downwardly therefrom, as well as a plurality of features defined therein, including: a forward slot 38, a pair of rearward slots 40, 42, a first or forward aperture 44, a second or intermediate aperture 46, and a pair of third or rearward apertures 48, 50. As described herein in more detail, the slots/apertures are configured to receive pins that are part of or support the function of the actuator assembly 18 and/or flexible strip system 20.

In the example implementation, the perimeter housing member 32 is coupled to and/or disposed between the main housing side walls 30 and generally includes an upper wall 60 and a lower wall 62 connected by a rear wall 64. The upper wall 60 includes an upper support arm 66 extending outwardly therefrom to couple to at least a portion of the carriage 16 for further support of the cartridge 24. Similarly, the lower wall 62 includes a lower support arm 68 extending outwardly therefrom to couple to at least a portion of the carriage 16 for even further support of the cartridge 24. As shown in FIG. 1, each of the upper and lower support arms 66, 68 define a track or channel 70 configured to guide a portion of the flexible strip system 20, as described herein in more detail.

With continued reference to FIGS. 1 and 2, the main housing forward wall 34 is coupled to and/or disposed between the main housing side walls 30. As illustrated, the carriage 16 is coupled to the main housing forward wall 34 and includes an upper carriage frame member 72, a lower carriage frame member 74, and a carriage end member 76. The upper carriage frame member 72 includes a proximal end 78 coupled to the forward wall 34, and a distal end 80 coupled to the carriage end member 76 and the upper support arm 66 (e.g., via a pin 82). Similarly, the lower carriage frame member 74 includes a proximal end 84 coupled to the forward wall 34, and a distal end 86 coupled to the carriage end member 76 and the lower support arm 68 (e.g., via a pin 88). As shown in FIG. 1, the carriage end member 76 includes a generally annular body 90 coupled to a generally annular end plate 92 defining an aperture 94 to receive the cartridge nozzle 26.

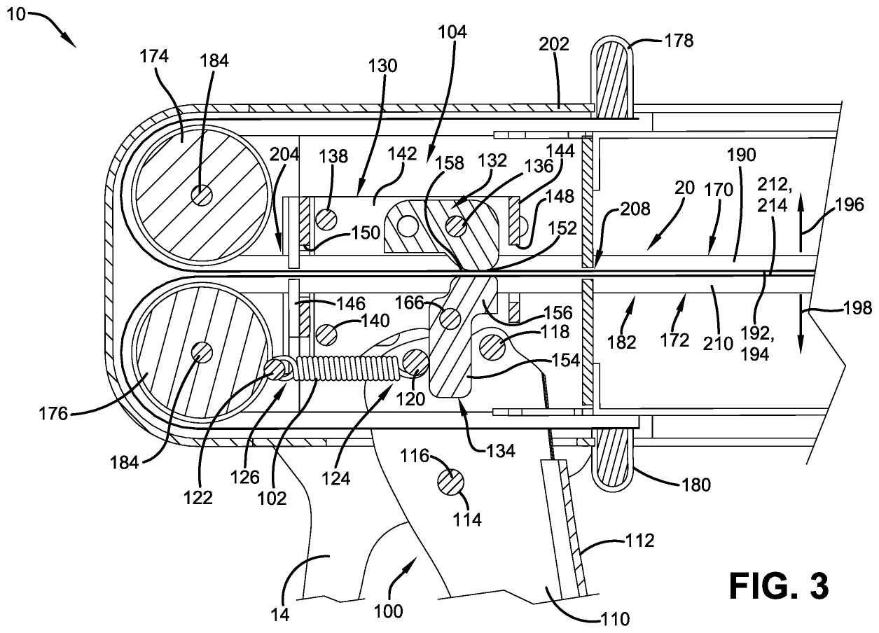

With reference now to FIGS. 2 and 3, actuator assembly 18 will be described in more detail. As described above, the actuator assembly 18 is configured to interact with the flexible strip system 20 to selectively deploy the plunger 22 and expel material from the cartridge 24. In the example embodiment, the actuator assembly 18 generally includes a trigger assembly 100, a biasing mechanism 102, and a carrier assembly 104.

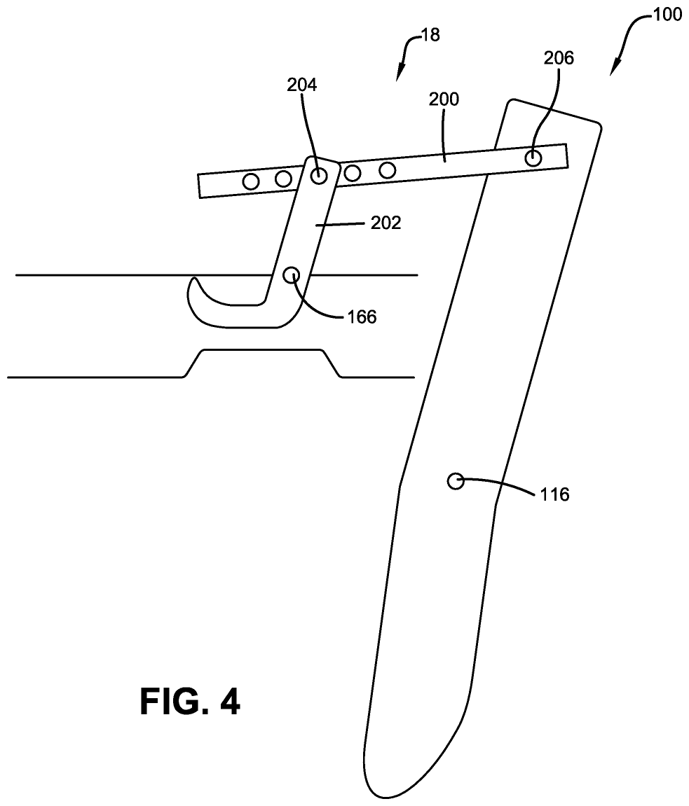

As shown, the trigger assembly 100 includes a pair of laterally spaced apart trigger plates 110 (see FIG. 1) connected by a gripping surface 112 configured to be gripped by a user for squeezing the trigger assembly 100 toward the handle 14. The trigger plates 110 each include an aperture 114 configured to align with one side wall forward aperture 44 to receive a pivot pin 116, thereby establishing a pivot point for trigger assembly 100 to rotate about. Additionally, a forward actuator pin 118 and a rearward actuator pin 120 are coupled to and extend between the spaced apart trigger plates 110. The forward and rearward actuator pins 118, 120 are configured to engage and slide the carrier assembly 104, as described herein in more detail. In alternative configurations, actuator pins 118, 120 may be a single actuator that engages the carrier assembly 104 (e.g., see FIG. 4).

As shown in the example implementation, a support pin 122 extends through the side wall intermediate apertures 46 to couple to and extend between the main housing side walls 30. The biasing mechanism 102 (e.g., a spring) includes a first end 124 and an opposite second end 126. The first end 124 is coupled to the rearward actuator pin 120, and the second end 126 is coupled to the support pin 122. In this way, the biasing mechanism 102 is configured to bias the rearward actuator pin 120 toward the support pin 122 to thereby rotate the trigger assembly 100 about the pivot pin 116 and away from the handle 14. This biasing force is also configured to bias the carrier assembly 104 into a rearward position, as shown in FIG. 3 and described herein in more detail.

In the example embodiment, the carrier assembly 104 generally includes a carrier housing 130, a pair of opposed grips including an upper grip 132 and a lower grip 134, a forward sliding pin 136, and a pair of rearward sliding pins 138, 140. The carrier housing 130 includes a pair of laterally spaced apart walls 142 (only one shown in FIGS. 2 and 3) disposed inboard of main housing side walls 30, a forward wall 144, and a rearward wall 146. The forward wall 144 includes an aperture 148, and the rearward wall 146 includes an aperture 150, to thereby each receive portions of the flexible strip system 20 therethrough.

The upper grip 132 is fixed between and relative to the carrier walls 142 and includes a gripping surface 152 configured to engage the flexible strip system 20. In alternative configurations, the upper grip may be rotatably coupled to the carrier housing 130. The lower grip 134 generally includes a contact portion 154 and a gripping portion 156 having a gripping surface 158. The lower grip 134 is rotatably coupled between the carrier walls 142 about a grip pin 166 and is configured to be selectively rotated upward toward the upper grip 132 to pinch or grip the flexible strip system 20 therebetween, as described herein in more detail.

As shown in FIG. 2, the forward sliding pin 136 and the rearward sliding pins 138, 140 are coupled to and extend through carrier housing walls 142, as well as extend through main housing side walls 30. In this way, as shown in FIG. 1, the forward sliding pin 136 is slidingly disposed within the forward slot 38, and the rearward sliding pins 138, 140 are slidingly disposed within the respective rearward slots 40, 42. As such, the carrier assembly 104 is configured to slide back and forth within the slots 38, 40, 42 formed within the main housing side walls 30 and is constrained by a length thereof. Advantageously, the slots maintain the alignment of the carrier assembly 104 relative to the carriage frame and the flexible strip system 20 for optimal performance.

FIG. 4 illustrates an alternative configuration of actuator assembly 18 that utilizes a single pin or linkage 200 for coupling trigger assembly 100 to a tape grip 202 (e.g., similar to lower grip 134) instead of the forward and rearward actuator pins 118, 120. Additionally, rather than requiring biasing mechanism 102 coupled to the rearward actuator pin 120 to return the trigger assembly 100 to the resting position, an alternative biasing mechanism such as, for example, a torsion spring (not shown) may be utilized. As shown in the example embodiment, rotation of the trigger assembly 100 about pivot pin 116 translates the linkage 200, which is rotatably coupled to the tape grip 202 at pin 204 and the trigger assembly 100 at pin 206. Forward and rearward translation of the linkage 200 causes rotation of the tape grip 202 about grip pin 166 to selectively engage and disengage the flexible strip. This alternative system advantageously provides strong engagement and disengagement, does not require a return spring, and is always disengaged at rest. However, it will be appreciated that actuator assembly 18 may have any suitable configuration that enables the actuator assembly to both push and pull the grip to engage and disengage the flexible tape and function as described herein.

With continued reference to FIGS. 2 and 3, flexible strip system 20 will be discussed in more detail. As described herein, flexible strip system 20 is configured to be engaged by actuator assembly 18 to selectively deploy the plunger 22 and expel caulk from the cartridge 24. In the example embodiment, the flexible strip system 20 generally includes a first or upper flexible strip or tape 170, a second or lower flexible strip or tape 172, a pair of rollers 174, 176, and a pair of retractor members or knobs 178, 180.

As described herein in more detail, the upper and lower flexible tapes 170, 172 work in tandem to establish a rigid rod-like or shaft-like member 182 for moving the plunger 22 within carriage 16, but which are separable and bend/flex around respective rollers 174, 176. As illustrated, the rollers 174, 176 are rotatably coupled to the main housing side walls 30 via support pins 184 received within rearward apertures 48, 50. The rollers 174, 176 define rounded guide channels configured to receive the flexible tapes 170, 172 from a first direction (e.g., from the carriage 16) and separately redirect each tape 170, 172 in a second direction (e.g., toward the carriage 16) along the upper and lower support arms 66, 68. However, alternative arrangements to the rollers are envisioned such as, for example, a pair of stationary semi-circles or rounded guides. Moreover, it is envisioned that the rollers 174, 176 may direct the flexible tapes 170, 172 in any suitable direction (e.g., to the handle 14) and/or storage location (e.g., coil the tape around the rollers) that enables extrusion dispenser assembly 10 to maintain a compact, fixed length configuration. The retractor knobs 178, 180 are coupled to the respective upper and lower flexible tapes 170, 172, and are configured to slide along the channels 70 formed in the upper and lower support arms 66, 68. This enables the flexible tapes 170, 172 to be retracted into the main housing 12 to enable removal of the cartridge 24.

In the example embodiment, the upper flexible tape 170 and the lower flexible tape 172 are each comprised of a generally rigid material (e.g., metal) having a concave-convex cross-sectional shape taken along a line perpendicular to a length thereof. The concave-convex shape may include various sections (e.g., central section between two lateral sections), with each section having a unique or common curvature of radius. The greater the curvature of the concave-convex shape, the deeper the concave-convex shapes are, which results in a higher rigidity of the tape. In some examples, the flexible tapes 170, 172 may be similar or identical to a metal tape commonly found in a conventional tape measure.

In this way, the upper flexible tape 170 is defined by a concave side 190 and an opposite convex side 192 having an apex or spine 194. Due to the concave-convex shape, the spine 194 and thus the upper flexible tape 170 are more easily bent in a first direction 196 (as shown in FIG. 3) toward the concave side 190, while being more rigid and resistant to bending in an opposite second direction 198 (as shown in FIG. 3) toward the convex side 192. In the example embodiment, the upper flexible tape 170 includes a first end 200 and an opposite second end 202. The first end 200 is coupled to the plunger 22, and the second end 202 is coupled to the upper retractor knob 178. As shown in FIG. 2, the upper flexible tape 170 extends through a first concave-convex shaped tape port 204 formed in a support wall 206, through the carrier assembly 104 between the upper and lower grips 132, 134, and subsequently through a second concave-convex shaped tape port 208 formed in the main housing forward wall 34.

Similarly, the lower flexible tape 172 is defined by a concave side 210 and an opposite convex side 212 having an apex or spine 214. Due to the concave-convex shape and orientation relative to the upper flexible tape 170, the spine 214 and thus the lower flexible tape 172 are more easily bent in the second direction 198 (as shown in FIG. 3) toward the concave side 210, while being more rigid and resistant to bending in the opposite first direction 196 (FIG. 3) toward the convex side 212. In the example embodiment, the lower flexible tape 172 includes a first end 216 and an opposite second end 218. The first end 216 is coupled to the plunger 22, and the second end 218 is coupled to the lower retractor knob 180. As shown in FIG. 2, the lower flexible tape 172 extends through the first tape port 204, through the carrier assembly 104 between the upper and lower grips 132, 134, and subsequently through the second tape port 208.

As shown, the upper and lower tapes 170, 172 are arranged with their respective spines 194, 214 facing and opposingly reinforcing each other. Due to this “back-to-back” or spine-to-spine mirror image orientation, the upper and lower tapes 170, 172 combine to form the rigid “shaft-like” member 182 for the plunger 22 that is resistant to flexure/bending in both the first direction 196 (via resistance from the lower tape 172) as well as the second direction 198 (via resistance from the upper tape 170). While not shown, the surfaces of tapes 170, 172 may include various features (e.g., projections, holes, etc.) that enable the tapes 170, 172 to further engage/support each other and establish the shaft member 182.

However, as shown in FIG. 2, the upper and lower tapes 170, 172 are separated as they approach the rollers 174, 176. As the separation occurs, due to the relatively easier bending/flexure toward the concave sides 190, 210, the upper tape 170 is free to bend and flex around the upper roller 174, while the lower tape 172 is free to bend and flex around the lower roller 176. This enables the tapes 170, 172 to be retracted back toward the carriage 16, without increasing the length of the caulk gun, as the shaft member is retracted, unlike the push rods of conventional caulk guns.

In one example operation of the extrusion dispenser assembly 10, the flexible strip system 20 is moved to the fully retracted position by sliding the retractor knobs 178, 180 along channels 70 toward the carriage end member 76, which retracts plunger 22 toward main housing 12. This provides clearance to load the cartridge 24 into the carriage 16. Once loaded, the internal piston 28 faces the plunger 22 and the cartridge nozzle 26 extends through and is supported by the carriage end member 76. To operate, the user then grasps the handle 14 and trigger assembly 100 and subsequently provides a squeezing force to pull the trigger assembly 100 rearward toward the handle 14.

This rearward movement causes the trigger assembly 100 to rotate about pivot pin 116, which forces the rearward actuator pin 120 into engagement with lower grip 134. This engagement causes subsequent rotation of the lower grip 134 around grip pin 166 such that contact portion 154 moves upward (as seen in FIG. 3) to thereby establish a compressive “gripping” force on the upper and lower flexible tapes 170, 172 between the upper grip 132 and lower grip 134 without transferring any significant rotary motion to the tapes.

With the flexible tapes 170, 172 secured between the grips 132, 134, the trigger assembly 100 continues to rotate and the rearward actuator pin 120 continues to provide a force against the lower grip 134. Once lower grip 134 is prevented by upper grip 132 from further rotation in the counter-clockwise direction (as viewed in FIG. 3), the continued force causes the carrier assembly 104 to shuttle forward (rightward as viewed in FIG. 3) via the forward sliding pin 136 and the rearward sliding pins 138, 140 sliding along the respective slots 38, 40, 42. This forward movement advances the flexible tapes 170, 172 through the tape port 208 in the main housing forward wall 34, thereby forcing plunger 22 into driving engagement with the cartridge internal piston 28 to expel caulk from the nozzle 26.

Upon release of the trigger assembly 100, biasing mechanism 102 operates to pull the rearward actuator pin 120 toward the support pin 122 to thereby reverse rotation of the trigger assembly 100 about pivot pin 116 (e.g., rotates counter-clockwise, FIG. 3). As such, the rearward actuator pin 120 no longer exerts force upon the lower grip 134, which immediately releases the compressive force on the flexible tapes 170, 172. As the trigger assembly 100 reverses rotation about pivot pin 116, the forward actuator pin 118 engages and provides force against the lower grip 134. This force is transferred via the grip pin 166 to cause the carrier assembly 104 to slide or shuttle rearward (left, as viewed in FIG. 3) as the pins 136, 138, 140 slide along slots 38, 40, 42. Advantageously, the grips 132, 134 completely disengage the flexible tapes 170, 172 before the carrier assembly 104 moves rearward, thus avoiding the “pullback” common with many conventional caulk guns where some forward movement of the push rod is lost during each trigger squeeze. Once the carrier assembly 104 and trigger assembly 100 return to the default resting position, the user may repeat the process to further advance the plunger 22 and expel more caulk. When the user wishes to unload the cartridge 24, the flexible strip system 20 is again moved to the fully retracted position by sliding the retractor knobs 178, 180 along channels 70 toward the carriage end member 76.

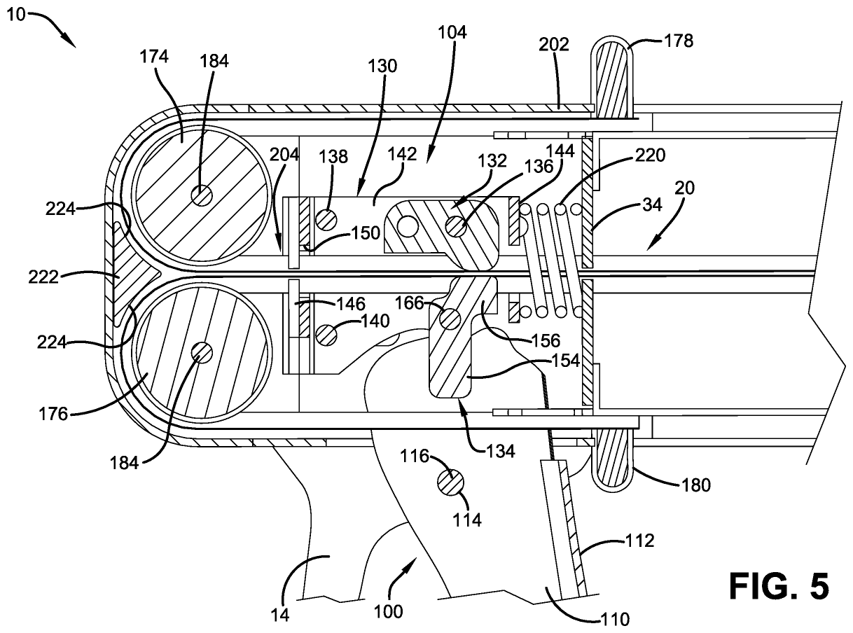

FIG. 5 illustrates an alternative configuration of actuator assembly 18 that utilizes a biasing mechanism 220 (e.g., a spring) and friction member 222 without biasing mechanism 102 or forward actuating pin 118. In the example embodiment, the biasing mechanism 220 is disposed between the carrier housing 130 (e.g., forward wall 144) and main housing forward wall 34 and is configured to bias the carrier assembly 104 rearward towards the rear wall 64. The friction member 222 is disposed against the rear wall 64 proximate to the rollers 174, 176 and defines curved, frictional surfaces 224 configured to frictionally engage the upper and lower flexible tapes 170, 172.

In operation, the user pulls the trigger assembly 100 and forces the rearward actuator pin 120 into engagement with the carrier assembly 104 to establish the gripping force to advance the flexible tapes 170, 172 forward. The force created through trigger assembly 100 is sufficient to overcome the biasing force of biasing mechanism 220 as well as friction between the flexible tapes 170, 172 and the friction member 222, thereby advancing the flexible tapes 170, 172 to cause plunger 22 to engage the cartridge internal piston 28. When the trigger assembly 100 is released, the gripping force is released and the biasing mechanism 222 returns the carrier assembly 104 rearward. Advantageously, however, the flexible tapes 170, 172 remain in place due to the frictional engagement with the friction member 222, which facilitates preventing rearward movement of the flexible tapes 170, 172 as the carrier assembly 104 returns to the resting position.

Described herein are systems and methods for a rodless caulking gun. The caulking gun includes a flexible strip system having two flexible metal strips or bands, each configured to be flexible in one direction along the perpendicular axis and resistant to flexing on the other direction of the perpendicular axis. A trigger assembly operates a carrier assembly to engage a cam to grip and feed the flexible bands. The trigger assembly advantageously disengages the cam upon release of the trigger assembly to prevent undesirable “pullback” and obviates the need for additional disengagement mechanisms to allow the pushrod to be pulled back and reset to its original position.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cartridge-based extrusion dispenser assembly comprising:
a carriage configured to hold a fluid cartridge;
a flexible strip system coupled to a plunger and including a first flexible tape operably associated with a second flexible tape, wherein within the carriage, the first and second flexible tapes opposingly reinforce each other to establish a substantially rigid shaft member within the carriage; and
an actuator assembly configured to feed the first and second flexible tapes into the carriage to advance the plunger to engage the fluid cartridge and dispense fluid therefrom.

2. The extrusion dispenser assembly of claim 1, wherein the first flexible tape has a concave-convex shape.

3. The extrusion dispenser assembly of claim 2, wherein the second flexible tape has a concave-convex shape, and
wherein a convex side of the first flexible tape is arranged against a convex side of the second flexible tape.

4. The extrusion dispenser assembly of claim 1, further comprising a first rounded guide channel configured to redirect the first flexible tape extending from the carriage back toward the carriage when the plunger is retracted; and
a second rounded guide channel configured to redirect the second flexible tape extending from the carriage back toward the carriage when the plunger is retracted.

5. The extrusion dispenser assembly of claim 1, further comprising:
a first support arm extending adjacent the carriage;
a first channel extending along the first support arm; and
a first retractor member coupled to a first end of the first flexible tape and slidingly disposed within the first channel, wherein sliding the first retractor member toward a distal end of the carriage retracts the first flexible tape and the plunger.

6. The extrusion dispenser assembly of claim 5, further comprising:
a second support arm extending adjacent the carriage;
a second channel extending along the second support arm; and
a second retractor member coupled to a first end of the second flexible tape and slidingly disposed within the second channel, wherein the sliding the second retractor member toward the distal end of the carriage retracts the second flexible tape and the plunger.

7. A cartridge-based extrusion dispenser assembly comprising:
a carriage configured to hold a fluid cartridge;
a shaft member extending at least partially into the carriage and coupled to a plunger; and
an actuator assembly configured to feed the shaft member into the carriage to advance the plunger to engage the fluid cartridge and dispense fluid therefrom, the actuator assembly including:
a carrier assembly including a pair of opposed grips configured to selectively grip the shaft member; and
a trigger assembly configured to, when actuated, move to (i) a first position to selectively engage the carrier assembly to actuate the pair of opposed grips and grip the shaft member, and (ii) a further second position to advance the carrier assembly and feed the shaft member into the carriage,
wherein when the trigger assembly is released from the second position, (i) the pair of opposed grips disengage the shaft, and (ii) the carrier assembly is retracted away from the carriage while the carrier assembly is disengaged from the shaft member to thereby facilitate preventing movement of the shaft member in the reverse direction.

8. The extrusion dispenser assembly of claim 7, wherein the actuator assembly further comprises a biasing mechanism configured to bias the trigger assembly to a resting position.

9. The extrusion dispenser assembly of claim 8, wherein when the trigger assembly is biased to the resting position, the trigger assembly engages the carrier assembly and forces the pair of opposed grips to disengage the shaft member.

10. The extrusion dispenser assembly of claim 9, wherein when the trigger assembly is biased to the resting position, the trigger assembly further engages the carrier assembly and retracts the carrier assembly away from the carriage while the carrier assembly is disengaged from the shaft member.

11. The extrusion dispenser assembly of claim 7, further comprising a main housing at least partially housing the actuator assembly.

12. The extrusion dispenser assembly of claim 11, wherein the carriage is slidingly coupled to the main housing.

13. The extrusion dispenser assembly of claim 11, wherein the trigger assembly is rotatably coupled to the main housing via a pivot pin.

14. The extrusion dispenser assembly of claim 7, wherein the pair of opposed grips includes a first grip coupled to the carrier assembly, and a second grip rotatably coupled to the carrier assembly.

15. The extrusion dispenser assembly of claim 14, wherein the trigger assembly further comprises:
an actuator pin configured to selectively engage and rotate the second grip into a first position where the shaft member is gripped between the first and second grips, and selectively engage and rotate the second grip into a second position away from the shaft member to thereby disengage the shaft member.

16. The extrusion dispenser assembly of claim 7, wherein the actuator assembly further comprises a biasing mechanism configured to bias the carrier assembly rearward and away from the carriage to a resting position.

17. The extrusion dispenser assembly of claim 7, further comprising a friction member configured to frictionally engage the shaft member to facilitate preventing reverse movement thereof when the trigger assembly is released.

18. A cartridge-based extrusion dispenser assembly comprising:
a carriage configured to hold a fluid cartridge;
a flexible strip system coupled to a plunger and including a first flexible tape operably associated with a second flexible tape, wherein within the carriage, the first and second flexible tapes opposingly reinforce each other to establish a substantially rigid shaft member; and
an actuator assembly configured to feed the shaft into the carriage to advance the plunger to engage the fluid cartridge and dispense fluid therefrom, the actuator assembly including:
a carrier assembly including a pair of opposed grips configured to selectively grip the shaft; and
a trigger assembly configured to, when actuated, move to (i) a first position to selectively engage the carrier assembly to actuate the pair of opposed grips and grip the shaft member, and (ii) a further second position to advance the carrier assembly and feed the shaft into the carriage,
wherein when the trigger assembly is released from the second position, (i) the pair of opposed grips disengage the shaft, and (ii) the carrier assembly is retracted away from the carriage while the carrier assembly is disengaged from the shaft member to thereby facilitate preventing movement of the shaft member in the reverse direction.

19. The extrusion dispenser assembly of claim 18, further comprising:
wherein the first and second flexible tapes each have a concave-convex shape;
first and second rotatable rollers configured to respectively redirect the first and second flexible tapes extending from the carriage back toward the carriage when the plunger is retracted;
a pair of support arms extending adjacent the carriage and each including a channel defined therein;
first and second retractor members respectively coupled to first ends of the first and second flexible tapes and each slidingly disposed within one channel; and
a biasing mechanism configured to bias the trigger assembly to a resting position.
